(19) United States
(12) Patent Application Publication
(10) Pub. No.: US 2026/0221786 A1
(43) Pub. Date: Jul. 30, 2026

(54) BATTERY SYSTEM AND METHOD OF OPERATING BATTERY SYSTEM

(71) Applicant: Caterpillar Inc., Peoria, IL (US)

(72) Inventors: Alexander Charles Brown, Spalding (GB); Stephen Edwards, Peterborough (GB)

(73) Assignee: Caterpillar Inc., Peoria, IL (US)

(21) Appl. No.: 19/040,974

(22) Filed: Jan. 30, 2025

(51) Int. Cl. H02J 7/00

(52) U.S. Cl. CPC H02J 7/50; H02J 7/60; H02J 7/80; H02J 7/855

(57) ABSTRACT

A battery system includes at least one battery string, at least two contactors, at least two sensors and a controller including one or more processors communicably coupled with the at least two contactors, and the at least two sensors. The one or more processors are configured to receive, from each of the at least two sensors, a first signal indicative of an operating parameter associated with the at least two contactors, estimate a remaining service life of each of the at least two contactors based on the first signal, compare the remaining service life of the at least two contactors with each other, determine a contactor, from the at least two contactors, that has a higher remaining service life, and at least one of establish and break a connection between a load and the battery system, via the contactor that has the higher remaining service life.

### TECHNICAL FIELD

The present disclosure relates to a battery system and a method of operating the battery system.

### BACKGROUND

A battery system is used in a variety of applications as a means of power supply. For example, the battery system is being increasingly implemented in passenger vehicles, construction machines, and the like, to provide power supply.

Typically, a high voltage battery system includes one or more battery strings. Each battery string may include any number of battery modules that store chemical energy and release electrical energy as a power source. The battery system also includes one or more contactors connected with the corresponding battery string. The contactors may be used to establish and/or break a connection i.e., an electric circuit between a load and the battery system. In an example, the contactors may be used to establish or break the electric circuit, thereby allowing a corresponding battery string of the battery system to be charged, discharged, or isolated.

The contactors will experience wear over a lifetime of the battery system and therefore need to be replaced. For example, a contactor needs to be replaced if the contactor is worn beyond a limit, otherwise the worn contactor may cause damage to the battery system and may also affect an operation of the battery system. During an operation of the battery system, the contactors open or close under different conditions, thereby experiencing different make/break current flows, which leads to wear of the contactors at different rates. Further, different specifications of the contactors may also lead to wear of the contactors at the different rates. It may be desirable to replace multiple contactors at the same time to reduce maintenance efforts. However, as the contactors wear at different rates, in some cases, only one contactor may have to be replaced at a time which may increase a number of maintenance events and efforts.

FR3123155 describes a smart battery pack for energy efficient and connected mobility for an electric propulsion system of an electric vehicle comprising: multicore lockstep microcontroller coupled with a safe power supply; battery pack comprising cell modules; relays configured to switch contactor connections; a battery thermal management system; and a short/long range communication module. The smart battery pack is designed to monitor cell-voltages to: perform cell voltage balancing; and/or perform open-circuit voltage measurements for State of Charge recalibration. The smart battery pack is designed to monitor the current flow to: avoid thermal runaway caused by current flow above operational limits; and/or ampere/hour counting for State of Charge estimation. The smart battery pack being further designed to: monitor the voltage and temperature in different vehicle operating mode to protect the cell from the degradation; measure battery current and pack voltage and calculate the State of Charge; control the battery contactor; and provide cell balancing mechanism.

### SUMMARY OF THE DISCLOSURE

In an aspect of the present disclosure, a battery system is provided. The battery system is connectable with a load. The battery system includes at least one battery string. The at least one battery string includes a plurality of battery modules. The battery system also includes at least two contactors connected to the at least one battery string. The battery system further includes at least two sensors corresponding to the at least two contactors. Each of the at least two sensors is configured to generate a first signal indicative of an operating parameter associated with a corresponding contactor from the at least two contactors. The battery system includes a controller including one or more memories and one or more processors communicably coupled with each of the one or more memories, the at least two contactors, and the at least two sensors. The one or more processors are configured to receive, from each of the at least two sensors, the first signal indicative of the operating parameter associated with the at least two contactors. The one or more processors are also configured to estimate a remaining service life of each of the at least two contactors based on the first signal received from each of the at least two sensors. The one or more processors are further configured to compare the remaining service life of the at least two contactors with each other. The one or more processors are configured to determine a contactor, from the at least two contactors, that has a higher remaining service life. The one or more processors are also configured to at least one of establish and break a connection between the load and the battery system, via the contactor that has the higher remaining service life.

In another aspect of the present disclosure, a method of operating a battery system is provided. The battery system is connectable with a load. The battery system includes at least one battery string and at least two contactors connected to the at least one battery string. The method includes generating, by at least two sensors associated with the at least two contactors of the at least one battery string, a first signal indicative of an operating parameter associated with a corresponding contactor from the at least two contactors. The method also includes receiving, by one or more processors of a controller, the first signal indicative of the operating parameter associated with the at least two contactors from each of the at least two sensors. The one or more processors are communicably coupled with each of one or more memories of the controller, the at least two contactors, and the at least two sensors. The method further includes estimating, by the one or more processors, a remaining service life of each of the at least two contactors based on the first signals received from the at least two sensors. The method includes comparing, by the one or more processors, the remaining service life of the at least two contactors with each other. The method also includes determining, by the one or more processors, a contactor, from the at least two contactors, that has a higher remaining service life. The method further includes at least one of establishing and breaking, by the one or more processors, a connection between the load and the battery system via the contactor that has the higher remaining service life.

Other features and aspects of this disclosure will be apparent from the following description and the accompanying drawings.

### BRIEF DESCRIPTION OF THE DRAWINGS

FIG. 1 is a circuit diagram of an exemplary battery system, according to an example of the present disclosure;

FIG. 2 is a schematic block diagram of the battery system of FIG. 1, according to an example of the present disclosure;

FIG. 3 is a schematic block diagram of the battery system of FIG. 1, according to another example of the present disclosure; and

FIG. 4 is a flowchart for a method of operating the battery system of FIG. 1, according to an example of the present disclosure.

### DETAILED DESCRIPTION

Wherever possible, the same reference numbers will be used throughout the drawings to refer to the same or like parts.

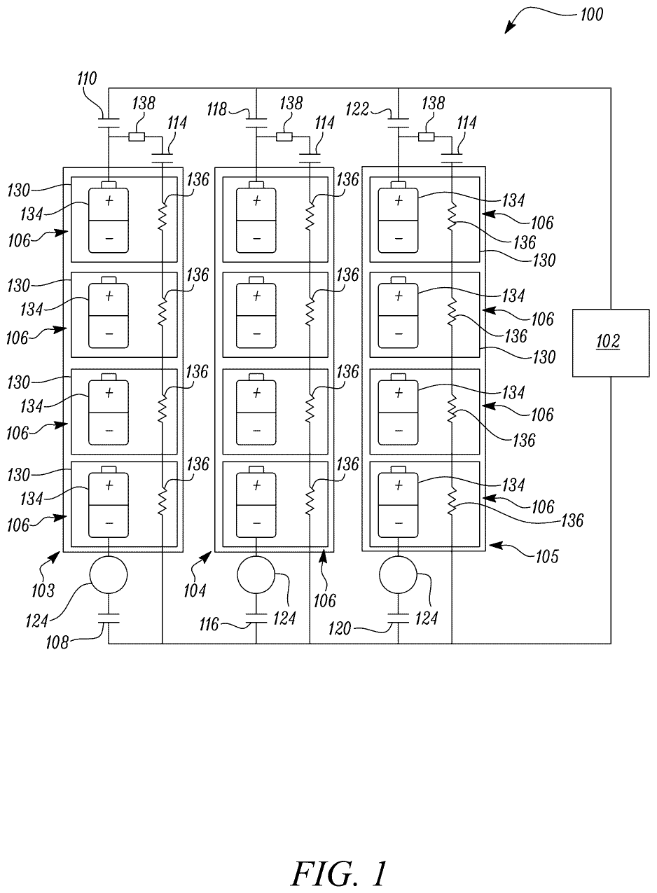

Referring to FIG. 1, a circuit diagram of an exemplary battery system 100 is illustrated. The battery system 100 may supply electrical power to a machine. The machine may include a moving machine or a stationary machine. In some examples, the machine may be a work/construction machine, for example.

The battery system 100 is connectable with a load 102. In some examples, the load 102 may be an alternating current (AC) load. In other examples, the load 102 may be a direct current (DC) load. In an example, the load 102 may be an electrical component associated with the machine.

The battery system 100 includes one or more battery strings 103, 104, 105. In some examples, the one or more battery strings 103, 104, 105 include two or more battery strings 103, 104. In the illustrated example of FIG. 1, the two or more battery strings 103, 104 include a first battery string 103 and a second battery string 104. The two or more battery strings 103, 104, 105 further include a third battery string 105. It should be noted that the battery strings 103, 104, 105 are illustrated in the battery system 100 of FIG. 1 as an example. Alternatively, the battery system 100 may include any number of battery strings, based on application attributes. The first battery string 103, the second battery string 104, and the third battery string 105 are hereinafter interchangeably referred to as “the one or more battery strings 103, 104, 105” or “the two or more battery strings 103, 104, 105”. Each of the first, second, and third battery strings 103, 104, 105 are connected in parallel with each other.

The one or more battery strings 103, 104, 105 include a number of battery modules 106. In the illustrated example of FIG. 1, each battery string 103, 104, 105 includes four battery modules 106. However, each battery string 103, 104, 105 may include any number of battery modules, as per application attributes. Each battery module 106 includes a housing 130. Each battery module 106 also includes a number of battery cells 134 disposed within the housing 130. The number of battery cells 134 may be electrically coupled to one another to provide a desired power output and voltage output to the load 102. A single battery cell 134 is illustrated in FIG. 1 as an example, however, each battery module 106 may include any number of battery cells, as per requirements.

The battery cells 134 may incorporate, for example, a lithium-ion battery technology to distribute the electrical power at a desired battery module voltage and a desired battery module amperage. It should be noted that the power distribution and power storage characteristics of the battery system 100 may be defined at least in part on the configurations of the battery cells 134 included in the battery system 100. In other examples, the battery system 100 may embody any other type of battery technology, such as a lead-acid battery technology, nickel metal hydride (NiMH) battery technology, and the like that converts chemical energy directly to electrical energy by utilizing a difference in bond energies of the compounds utilized in the construction of the battery module 106. Further, the battery cells 134 may include any capacity, voltage, energy, etc.

The battery system 100 also includes two or more contactors 108, 110, 112, 114, 116, 118, 120, 122 connected to the one or more battery strings 103, 104, 105. The two or more contactors 108, 110, 112, 114, 116, 118, 120, 122 may switch between an open state and a closed state to establish and/or break a connection associated with a circuit of the battery system 100.

The two or more contactors 108, 110, 112, 114, 116, 118, 120, 122 include a first contactor 108, 116, 120 connected to a negative output of the one or more battery strings 103, 104, 105. Specifically, the first contactor 108 is connected to the negative output of the first battery string 103. The first contactor 108, 116, 120 is also known in the art as a negative contactor.

The two or more contactors 108, 110, 112, 114, 116, 118, 120, 122 also include a second contactor 110, 118, 122 connected to a positive output of the one or more battery strings 103, 104, 105. Specifically, the second contactor 110 is connected to the positive output of the first battery string 103. The second contactor 110, 118, 122 is also known in the art as a positive contactor.

Further, the two or more contactors 108, 110, 112, 114, 116, 118, 120, 122 include a first contactor 116 connected to a negative output of the second battery string 104. The two or more contactors 108, 110, 112, 114, 116, 118, 120, 122 further includes a second contactor 118 connected to a positive output of the second battery string 104.

The two or more contactors 108, 110, 112, 114, 116, 118, 120, 122 includes a first contactor 120 connected to a negative output of the third battery string 105. The two or more contactors 108, 110, 112, 114, 116, 118, 120, 122 further includes a second contactor 122 connected to a positive output of the third battery string 105.

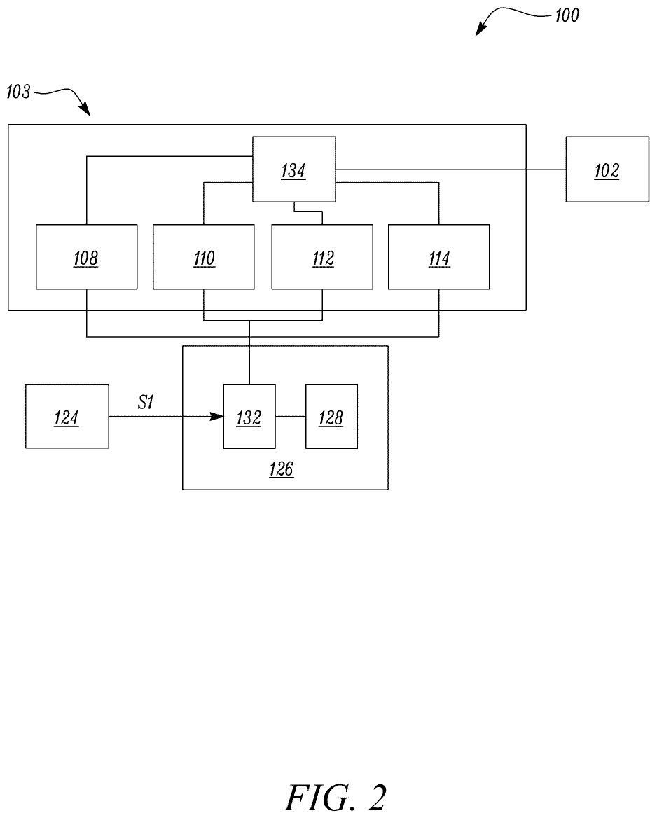

The two or more contactors 108, 110, 112, 114, 116, 118, 120, 122 further include a pre-charge contactor 112 (shown in FIG. 2) connected to the one or more battery strings 103, 104, 105 and a heating contactor 114 connected to the one or more battery strings 103, 104, 105. Specifically, each of the first battery string 103, the second battery string 104, and the third battery string 105 includes a corresponding pre-charge contactor 112 and a corresponding heating contactor 114. The pre-charge contactor 112 may allow a current to flow in a corresponding battery string 103, 104, 105 in a controlled manner. Although a single pre-charge contactor 112 is shown herein, the battery system 100 may include multiple pre-charge contactors associated with the first contactor 108, 116, 120 and the second contactor 110, 118, 122 of the corresponding battery string 103, 104, 105, as per application requirements. Specifically, the battery system 100 may include one pre-charge contactor associated with the first contactor 108, 116, 120 and one pre-charge contactor associated with the second contactor 110, 118, 122.

The heating contactor 114 may be used to enable heating of the corresponding battery string 103, 104, 105 via a heater 136 of the battery system 100. The heater 136 may be switched on/off based on feedback from a battery thermal management system (not shown) of the battery system 100.

It should be noted that the first contactor 108, the second contactor 110, the first contactor 116, the second contactor 118, the first contactor 120, the second contactor 122, the pre-charge contactor 112, and the heating contactor 114 are hereinafter interchangeably and collectively referred to as “the two or more contactors 108, 110, 112, 114, 116, 118, 120, 122”.

The battery system 100 further includes two or more sensors 124 corresponding to the two or more contactors 108, 110, 112, 114, 116, 118, 120, 122. Each of the two or more sensors 124 generates a first signal S1 (shown in FIG. 2) indicative of an operating parameter associated with a corresponding contactor 108, 110, 112, 114, 116, 118, 120, 122 from the two or more contactors 108, 110, 112, 114, 116, 118, 120, 122. Each of the two or more sensors 124 includes a voltage sensor and/or a current sensor. In the illustrated example of FIG. 1, the sensor 124 includes a current sensor. Further, the operating parameter associated with each of the two or more contactors 108, 110, 112, 114, 116, 118, 120, 122 includes a current across the corresponding contactor 108, 110, 112, 114, 116, 118, 120, 122 from the two or more contactors 108, 110, 112, 114, 116, 118, 120, 122 and/or a voltage across the corresponding contactor 108, 110, 112, 114, 116, 118, 120, 122 from the two or more contactors 108, 110, 112, 114, 116, 118, 120, 122.

Each battery string 103, 104, 105 of the battery system 100 further includes a fuse 138 connected with the corresponding contactor 110, 118, 122 and the heating contactor 114 of the corresponding battery string 103, 104, 105. The fuse 138 may provide an overcurrent protection to the corresponding battery string 103, 104, 105.

Referring to FIG. 2, a schematic block diagram of the battery system 100 of FIG. 1 is illustrated, according to an example of the present disclosure. Only the first battery string 103 is illustrated in FIG. 2 as an example. However, details provided herein are equally applicable to the other battery strings 104, 105 (see FIG. 1). The battery system 100 further includes a controller 126. The controller 126 includes one or more memories 128 and one or more processors 132 communicably coupled with each of the one or more memories 128, the two or more contactors 108, 110, 112, 114, and the two or more sensors 124.

The one or more memories 128 may include any means of storing information, including a hard disk, an optical disk, a floppy disk, read only memory (ROM), random access memory (ROM), programmable ROM (PROM), electrically erasable PROM (EEPROM), or other computer-readable memory media.

It should be noted that the one or more processors 132 may embody a single microprocessor or multiple microprocessors for receiving various input signals and generating output signals. Numerous commercially available microprocessors may perform the functions of the processors 132. The one or more processors 132 may further include a general processor, a central processing unit, an application specific integrated circuit (ASIC), a digital signal processor, a field programmable gate array (FPGA), a digital circuit, an analog circuit, a microcontroller, any other type of processor, or any combination thereof. The one or more processors 132 may include one or more components that may be operable to execute computer executable instructions or computer code that may be stored and retrieved from the one or more memories 128.

The one or more processors 132 receive, from each of the two or more sensors 124, the first signal S1 indicative of the operating parameter associated with the two or more contactors 108, 110, 112, 114.

The one or more processors 132 estimate a remaining service life of each of the two or more contactors 108, 110, 112, 114 based on the first signal S1 received from each of the two or more sensors 124. Specifically, the one or more processors 132 determine the remaining service life of each of the two or more contactors 108, 110, 112, 114 by determining a state of wear of each of the two or more contactors 108, 110, 112, 114 based on the first signal S1.

The one or more processors 132 further compare the remaining service life of the two or more contactors 108, 110, 112, 114 with each other.

The one or more processors 132 determine a contactor 108, 110, 112, 114 from the two or more contactors 108, 110, 112, 114 that has a higher remaining service life.

The one or more processors 132 establish and/or break the connection between the load 102 and the battery system 100, via the contactor 108, 110 that has the higher remaining service life.

Specifically, in the illustrated example of FIG. 2, the one or more processors 132 compare the remaining service life of the first contactor 108 with the remaining service life of the second contactor 110. Further, the one or more processors 132 determine which of the first contactor 108 and the second contactor 110 has the higher remaining service life. Furthermore, the one or more processors 132 establish and/or break the connection between the load 102 and the battery system 100 via the first contactor 108 and/or the second contactor 110 that has the higher remaining service life. For example, if the first contactor 108 has a higher remaining service life than the second contactor 110, the one or more processors 132 establish and/or break the connection between the load 102 and the battery system 100 via the first contactor 108. Thus, at the string level, the processors 132 determine which of the first and second contactors 108, 110 of the battery string 103 has the higher remaining service life, and the processor 132 uses the contactor 108, 110 with the higher remaining service life to establish or break the connection between the battery string 103 and the load 102.

In another example, if the two or more contactors 108, 110, 112, 114 include two pre-charge contactors, the one or more processors 132 may determine a pre-charge contactor from the two pre-charge contactors with the higher remaining service life to pre-charge in order to effect the battery string 103 coming online via its corresponding first and/or second contactors 108, 110.

In a similar manner, the one or more processors 132 establish and/or break a connection between the battery string 104, 105 and the load 102 via the contactor 116, 118, 120, 122 (see FIG. 1) that has the higher remaining service life.

Further, the one or more processors 132 enable and/or disable the heater 136 of the one or more battery strings 103 via the contactor 108, 110, 112, 114 that has the higher remaining service life. For this purpose, the processors 132 first determine the remaining service life of each contactor 108, 110, 112, 114. Subsequently, the processors 132 compare the remaining service life of each contactor 108, 110, 112, 114 with each other to determine which contactor 108, 110, 112, 114 has the higher remaining service life. Further, the one or more processors 132 enable and/or disable the heater 136 of the first battery string 103 via the contactor 108, 110, 112, 114 that has the higher remaining service life. For example, if the second contactor 110 has the higher remaining service life than the first contactor 108, the heating contactor 114, and the pre-charge contactor 112, then the one or more processors 132 enable and/or disable the heater 136 of the one or more battery strings 103 via the second contactor 110. In a similar manner, the one or more processors 132 enable and/or disable the heater 136 of the one or more battery strings 104, 105 via the contactor 112, 114, 116, 118, 120, 122 that has the higher remaining service life.

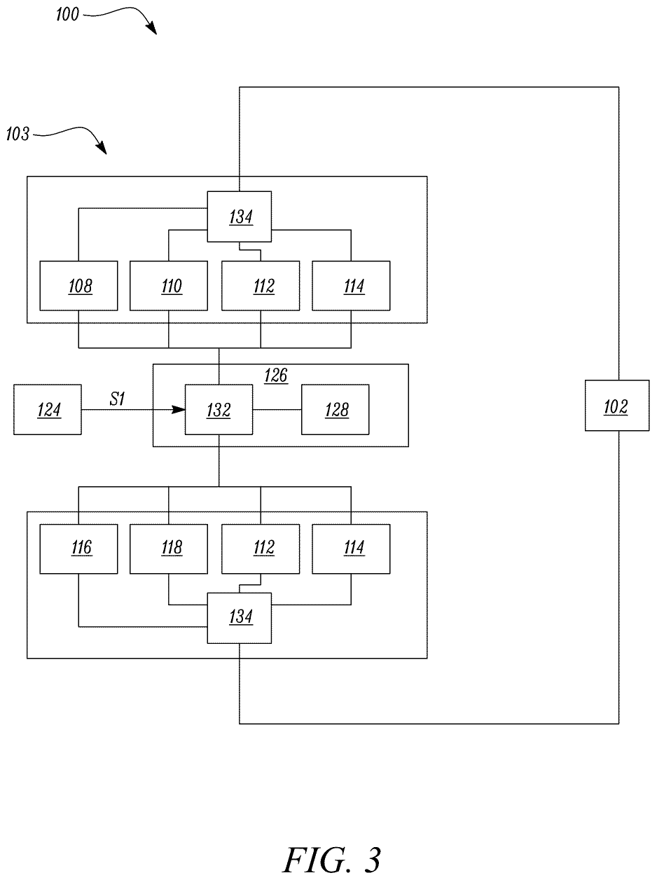

Referring now to FIG. 3, a schematic block diagram of the battery system 100 of FIG. 1 is illustrated, according to another example of the present disclosure. The first battery string 103 and the second battery string 104 are illustrated in FIG. 2 as an example. However, the details provided herein are equally applicable to the battery strings 103, 104, 105. The one or more processors 132 compare the remaining service life of the first contactor 108 of the first battery string 103, the second contactor 110 of the first battery string 103, the first contactor 116 of the second battery string 104, and the second contactor 118 of the second battery string 104 with each other.

The one or more processors 132 determine which of the first contactor 108 of the first battery string 103, the second contactor 110 of the first battery string 103, the first contactor 116 of the second battery string 104, and the second contactor 118 of the second battery string 104 has the higher remaining service life.

The one or more processors 132 establish and/or break the connection between the load 102 and the battery system 100 via the first contactor 108 of the first battery string 103, the second contactor 110 of the first battery string 103, the first contactor 116 of the second battery string 104, and/or the second contactor 118 of the second battery string 104 that has the higher remaining service life. For example, if the first contactor 116 of the second battery string 104 has a higher remaining service life than the first contactor 108 of the first battery string 103, the second contactor 110 of the first battery string 103, and the second contactor 118 of the second battery string 104, the one or more processors 132 establish and/or break the connection between the load 102 and the battery system 100 via the first contactor 116 of the second battery string 104. Thus, in such cases, the second battery string 104 is brought online first, followed by the first battery string 103.

Thus, at the battery system level, the processors 132 determine which of the first and second contactors 108, 110, 116, 118 of the battery string 103, 104 has the higher remaining service life, and the processors 132 use the contactor 108, 110, 116, 118 with the higher remaining service life to establish or break the connection between the battery string 103, 104 and the load 102.

It should be noted that a comparison between the contactors 108, 110, 116, 118 is explained herein as an example, however, in actual implementation, the processors 132 will compare the service life of the contactors 108, 110, 116, 118, 120, 122 (see FIG. 1) of each battery string 103, 104 105 (see FIG. 1) with each other, to determine the contactor 108, 110, 116, 118, 120, 122 that should be used to establish and/or break the connection between the load 102 and the battery system 100.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### Industrial Applicability

The present disclosure is directed towards the battery system 100. The battery system 100 includes the two or more contactors 108, 110, 112, 114, 116, 118, 120, 122 associated with the two or more battery strings 103, 104, 105. The processors 132 of the controller 126 estimates the remaining service life for each contactor 108, 110, 112, 114, 116, 118, 120, 122 to modify the opening/closing sequence of the contactors 108, 110, 112, 114, 116, 118, 120, 122, based on a receipt of a request to bring the battery system 100 online or a request to enable the heater 136.

The battery system 100 may minimize the wear across the two or more contactors 108, 110, 112, 114, 116, 118, 120, 122 by optimizing current and voltage differences and therefore, may even out the wear across the two or more contactors 108, 110, 112, 114, 116, 118, 120, 122. In other words, as the contactors 108, 110, 112, 114, 116, 118, 120, 122 operate under different conditions and may experience different current flows, the processors 132 may modify the opening/closing sequence of the contactors 108, 110, 112, 114, 116, 118, 120, 122 and therefore, may even out the wear across the two or more contactors 108, 110, 112, 114, 116, 118, 120, 122.

To realize this feature, the battery system 100 includes the one or more processors 132 that controls a switching of the two or more contactors 108, 110, 112, 114, 116, 118, 120, 122 between the open state and the closed state such that each of the contactors 108, 110, 112, 114, 116, 118, 120, 122 may have a similar state of wear. The processors 132 may optimize wear of each of the two or more contactors 108, 110, 112, 114, 116, 118, 120, 122 within the battery system 100 by modifying the opening/closing sequence of the contactors 108, 110, 112, 114, 116, 118, 120, 122. Thus, the battery system 100 may maximize a service life of the contactors 108, 110, 112, 114, 116, 118, 120, 122 before a need to replace the contactors 108, 110, 112, 114, 116, 118, 120, 122 without causing failure. Moreover, in an event of a critical contactor opening event, the contactor 108, 110, 116, 118, 120, 122 with the higher remaining service life may be opened first to ensure that the contactors 108, 110, 116, 118, 120, 122 open without failing. At the battery system level, the estimation of the higher remaining service life of each contactor 108, 110, 116, 118, 120, 122 may be used to determine which battery string 103, 104, 105 should be brought online first to connect the load 102 with the battery system 100. Further, at a battery string level, the estimation of the higher remaining service life of each contactor 108, 110, 116, 118, 120, 122 may be used to determine via which contactor 108, 110, 116, 118, 120, 122 of the battery string 103, 104, 105 should be brought online first to connect the load 102 with the battery system 100.

Further, in situations wherein the battery system 100 includes multiple pre-charge contactors, and if any one of the pre-charge contactors is in imminent danger of failing or is unable to establish a circuit as pre-charge is not possible, then the processors 132 may use another pre-charge contactor to pre-charge to cause the corresponding battery string 103, 104, 105 to come online via its corresponding first and/or second contactor 108, 110, 116, 118, 120, 122.

The battery system 100 uses the healthiest contactor 108, 110, 116, 118, 120, 122 to break the connection between the load 102 and the battery system 100, thereby ensuring operation of the battery system 100 in a desired manner without failure. In an example, when a battery management system (BMS) senses a discrepancy in the operation of the battery system 100 and may not have time to shed load in a correct manner, the one or more processors 132 may quickly break the connection between the load 102 and the battery system 100 via the healthiest contactor 108, 110, 112, 118, 120, 122 regardless of current draw at that instance.

Further, the battery system 100 may allow service and/or replacement of the contactors 108, 110, 112, 114, 116, 118, 120, 122 at once, instead of service and/or replacement of one contactor at a time, thereby reducing costs associated with the service and/or replacement.

Overall, the battery system 100 described herein is simple in construction and may be cost-effective. The present disclosure may also increase an interval time between repairs and/or replacement of the contactors 108, 110, 112, 114, 116, 118, 120, 122.

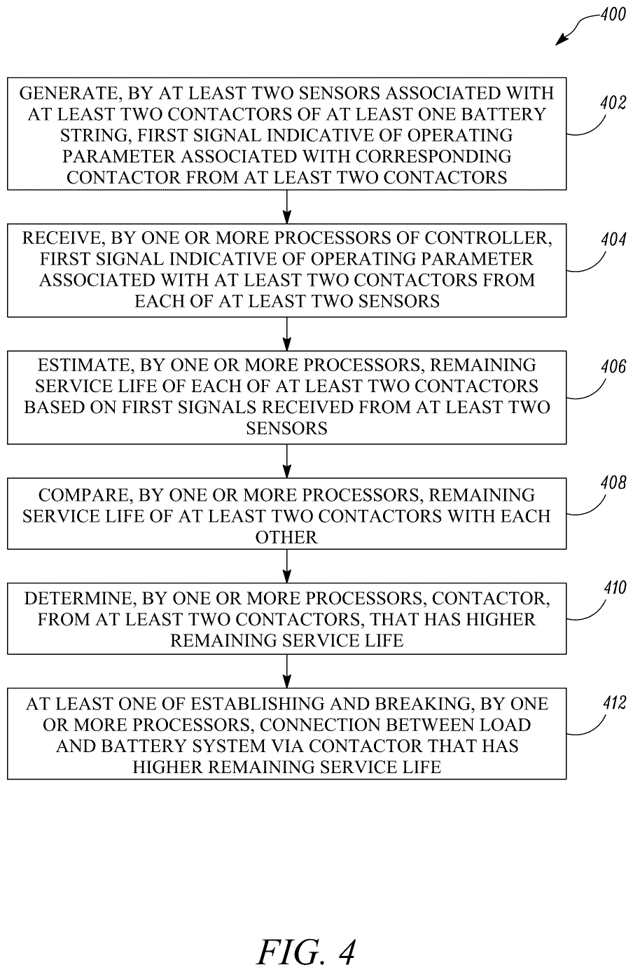

FIG. 4 is a flowchart for a method 400 of operating the battery system 100 of FIG. 1. The battery system 100 is connectable with the load 102. The battery system 100 includes the one or more battery strings 103, 104, 105 and the two or more contactors 108, 110, 112, 114, 116, 118, 120, 122 connected to the one or more battery strings 103, 104, 105. The one or more battery strings 103, 104, 105 includes the two or more battery strings 103, 104, 105. The two or more battery strings 103, 104, 105 include the first battery string 103 and the second battery string 104.

The two or more contactors 108, 110, 112, 114, 116, 118, 120, 122 include the first contactor 108, 116, 120 connected to the negative output of the one or more battery strings 103, 104, 105. Specifically, the two or more contactors 108, 110, 112, 114, 116, 118, 120, 122 include the first contactor 108 connected to the negative output of the first battery string 103. The two or more contactors 108, 110, 112, 114, 116, 118, 120, 122 also include the second contactor 110, 118, 122 connected to the positive output of the one or more battery strings 103, 104, 105. Specifically, the two or more contactors 108, 110, 112, 114, 116, 118, 120, 122 include the second contactor 110 connected to the positive output of the first battery string 103. The two or more contactors 108, 110, 112, 114, 116, 118, 120, 122 also include the pre-charge contactor 112 connected to the one or more battery strings 103, 104, 105 and the heating contactor 114 connected to the one or more battery strings 103, 104, 105. The two or more contactors 108, 110, 112, 114, 116, 118, 120, 122 further includes the first contactor 116 connected to the negative output of the second battery string 104 and the second contactor 118 connected to the positive output of the second battery string 104.

With reference to FIGS. 1 to 4, at step 402, the two or more sensors 124 associated with the two or more contactors 108, 110, 112, 114, 116, 118, 120, 122 of the one or more battery strings 103, 104, 105 generate the first signal S1 indicative of the operating parameter associated with the corresponding contactor 108, 110, 112, 114, 116, 118, 120, 122 from the two or more contactors 108, 110, 112, 114, 116, 118, 120, 122. Each of the two or more sensors 124 includes the voltage sensor and/or the current sensor. Further, the operating parameter associated with each of the two or more contactors 108, 110, 112, 114, 116, 118, 120, 122 includes the current across the corresponding contactor 108, 110, 112, 114, 116, 118, 120, 122 from the two or more contactors 108, 110, 112, 114, 116, 118, 120, 122 and/or the voltage across the corresponding contactor from the two or more contactors 108, 110, 112, 114, 116, 118, 120, 122.

At step 404, the one or more processors 132 of the controller 126 receive the first signal S1 indicative of the operating parameter associated with the two or more contactors 108, 110, 112, 114, 116, 118, 120, 122 from each of the two or more sensors 124. The one or more processors 132 are communicably coupled with each of one or more memories 128 of the controller 126, the two or more contactors 108, 110, 112, 114, 116, 118, 120, 122, and the two or more sensors 124.

At step 406, the one or more processors 132 estimate the remaining service life of each of the two or more contactors 108, 110, 112, 114, 116, 118, 120, 122 based on the first signals S1 received from the two or more sensors 124. The step 406 further includes determining the state of wear of each of the two or more contactors 108, 110, 112, 114, 116, 118, 120, 122 based on the first signal S1 received from the two or more sensors 124.

At step 408, the one or more processors 132 compare the remaining service life of the two or more contactors 108, 110, 112, 114, 116, 118, 120, 122 with each other.

At step 410, the one or more processors 132 determine the contactor 108, 110, 112, 114, 116, 118, 120, 122 from the two or more contactors 108, 110, 112, 114, 116, 118, 120, 122, that has the higher remaining service life.

At step 412, the one or more processors 132 establish and/or break the connection between the load 102 and the battery system 100 via the contactor 108, 110, 116, 118, 120, 122 that has the higher remaining service life.

The method 400 further includes a step (not shown) at which the one or more processors 132 enable and/or disable the heater 136 of the one or more battery strings 103, 104, 105 via the contactor 108, 110, 112, 114, 116, 118, 120, 122 that has the higher remaining service life.

With reference to FIGS. 1, 2 and 4, the method 400 includes a step (not shown) at which the one or more processors 132 compare the remaining service life of the first contactor 108, 116, 120 with the remaining service life of the second contactor 110, 118, 122. The method 400 also includes a step (not shown) at which the one or more processors 132 determine which of the first contactor 108, 116, 120 and the second contactor 110, 118, 122 has the higher remaining service life. The method 400 further includes a step (not shown) at which the one or more processors 132 establish and/or break the connection between the load 102 and the battery system 100 via the first contactor 108, 116, 120 and/or the second contactor 110, 118, 122 that has the higher remaining service life.

With reference to FIGS. 1, 3 and 4, the method 400 includes a step (not shown) at which the one or more processors 132 compare the remaining service life of the first contactor 108 of the first battery string 103, the second contactor 110 of the first battery string 103, the first contactor 116 of the second battery string 104, and the second contactor 118 of the second battery string 104 with each other. The method 400 also includes a step (not shown) at which the one or more processors 132 determine which of the first contactor 108 of the first battery string 103, the second contactor 110 of the first battery string 103, the first contactor 116 of the second battery string 104, and the second contactor 118 of the second battery string 104 has the higher remaining service life. The method 400 further includes a step (not shown) at which the one or more processors 132 establish and/or break the connection between the load 102 and the battery system 100 via the first contactor 108 of the first battery string 103, the second contactor 110 of the first battery string 103, the first contactor 116 of the second battery string 104, and/or the second contactor 118 of the second battery string 104 that has the higher remaining service life.

It should be noted that the steps 402, 404, 406, 408, 410, 412 of the method 400 may be performed in a sequence that is different from that explained in relation to FIG. 4. Further, various steps 402, 404, 406, 408, 410, 412 can be performed together.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A battery system, the battery system is connectable with a load, the battery system comprising:
at least one battery string, wherein the at least one battery string includes a plurality of battery modules;
at least two contactors connected to the at least one battery string;
at least two sensors corresponding to the at least two contactors, wherein each of the at least two sensors is configured to generate a first signal indicative of an operating parameter associated with a corresponding contactor from the at least two contactors; and
a controller including one or more memories and one or more processors communicably coupled with each of the one or more memories, the at least two contactors, and the at least two sensors, wherein the one or more processors are configured to:
receive, from each of the at least two sensors, the first signal indicative of the operating parameter associated with the at least two contactors;
estimate a remaining service life of each of the at least two contactors based on the first signal received from each of the at least two sensors;
compare the remaining service life of the at least two contactors with each other;
determine a contactor, from the at least two contactors, that has a higher remaining service life; and
at least one of establish and break a connection between the load and the battery system, via the contactor that has the higher remaining service life.

2. The battery system of claim 1, wherein the at least two contactors include a first contactor connected to a negative output of the at least one battery string and a second contactor connected to a positive output of the at least one battery string.

3. The battery system of claim 2, wherein the one or more processors are further configured to:
compare the remaining service life of the first contactor with the remaining service life of the second contactor;
determine which of the first contactor and the second contactor has the higher remaining service life; and
at least one of establish and break the connection between the load and the battery system via at least one of the first contactor and the second contactor that has the higher remaining service life.

4. The battery system of claim 1, wherein the one or more processors are further configured to at least one of enable and disable a heater of the at least one battery string via the contactor that has the higher remaining service life.

5. The battery system of claim 1, wherein the at least two contactors include:
a first contactor connected to a negative output of the at least one battery string;
a second contactor connected to a positive output of the at least one battery string;
a pre-charge contactor connected to the at least one battery string; and
a heating contactor connected to the at least one battery string.

6. The battery system of claim 1, wherein the at least one battery string includes at least two battery strings, wherein the at least two battery strings includes a first battery string and a second battery string, and wherein the at least two contactors include:
a first contactor connected to a negative output of the first battery string;
a second contactor connected to a positive output of the first battery string;
a first contactor connected to a negative output of the second battery string; and
a second contactor connected to a positive output of the second battery string.

7. The battery system of claim 6, wherein the one or more processors are further configured to:
compare the remaining service life of the first contactor of the first battery string, the second contactor of the first battery string, the first contactor of the second battery string, and the second contactor of the second battery string with each other;
determine which of the first contactor of the first battery string, the second contactor of the first battery string, the first contactor of the second battery string, and the second contactor of the second battery string has the higher remaining service life; and
at least one of establish and break the connection between the load and the battery system via at least one of the first contactor of the first battery string, the second contactor of the first battery string, the first contactor of the second battery string, and the second contactor of the second battery string that has the higher remaining service life.

8. The battery system of claim 1, wherein each of the at least two sensors includes at least one of a voltage sensor and a current sensor.

9. The battery system of claim 1, wherein the operating parameter associated with each of the at least two contactors includes at least one of a current across the corresponding contactor from the at least two contactors and a voltage across the corresponding contactor from the at least two contactors.

10. The battery system of claim 1, wherein the one or more processors are configured to determine the remaining service life of each of the at least two contactors by determining a state of wear of each of the at least two contactors based on the first signal received from each of the at least two sensors.

11. A method of operating a battery system, the battery system is connectable with a load, the battery system includes at least one battery string and at least two contactors connected to the at least one battery string, the method comprising:
generating, by at least two sensors associated with the at least two contactors of the at least one battery string, a first signal indicative of an operating parameter associated with a corresponding contactor from the at least two contactors;
receiving, by one or more processors of a controller, the first signal indicative of the operating parameter associated with the at least two contactors from each of the at least two sensors, wherein the one or more processors are communicably coupled with each of one or more memories of the controller, the at least two contactors, and the at least two sensors;
estimating, by the one or more processors, a remaining service life of each of the at least two contactors based on the first signals received from the at least two sensors;
comparing, by the one or more processors, the remaining service life of the at least two contactors with each other;
determining, by the one or more processors, a contactor, from the at least two contactors, that has a higher remaining service life; and
at least one of establishing and breaking, by the one or more processors, a connection between the load and the battery system via the contactor that has the higher remaining service life.

12. The method of claim 11, wherein the at least two contactors include a first contactor connected to a negative output of the at least one battery string and a second contactor connected to a positive output of the at least one battery string.

13. The method of claim 12 further comprising:
comparing, by the one or more processors, the remaining service life of the first contactor with the remaining service life of the second contactor;
determining, by the one or more processors, which of the first contactor and the second contactor has the higher remaining service life; and
at least one of establishing and breaking, by the one or more processors, the connection between the load and the battery system via at least one of the first contactor and the second contactor that has the higher remaining service life.

14. The method of claim 11 further comprising, at least one of enabling and disabling, by the one or more processors, a heater of the at least one battery string via the contactor that has the higher remaining service life.

15. The method of claim 11, wherein the at least two contactors include:
a first contactor connected to a negative output of the at least one battery string;
a second contactor connected to a positive output of the at least one battery string;
a pre-charge contactor connected to the at least one battery string; and
a heating contactor connected to the at least one battery string.

16. The method of claim 11, wherein the at least one battery string includes at least two battery strings, wherein the at least two battery strings includes a first battery string and a second battery string, and wherein the at least two contactors include:
a first contactor connected to a negative output of the first battery string;
a second contactor connected to a positive output of the first battery string;
a first contactor connected to a negative output of the second battery string; and
a second contactor connected to a positive output of the second battery string.

17. The method of claim 16 further comprising:
comparing, by the one or more processors, the remaining service life of the first contactor of the first battery string, the second contactor of the first battery string, the first contactor of the second battery string, and the second contactor of the second battery string with each other;
determining, by the one or more processors, which of the first contactor of the first battery string, the second contactor of the first battery string, the first contactor of the second battery string, and the second contactor of the second battery string has the higher remaining service life; and
at least one of establishing and breaking, by the one or more processors, the connection between the load and the battery system via at least one of the first contactor of the first battery string, the second contactor of the first battery string, the first contactor of the second battery string, and the second contactor of the second battery string that has the higher remaining service life.

18. The method of claim 11, wherein each of the at least two sensors includes at least one of a voltage sensor and a current sensor.

19. The method of claim 11, wherein the operating parameter associated with each of the at least two contactors includes at least one of a current across the corresponding contactor from the at least two contactors and a voltage across the corresponding contactor from the at least two contactors.

20. The method of claim 11, wherein the step of estimating, by the one or more processors, the remaining service life of each of the at least two contactors further includes determining a state of wear of each of the at least two contactors based on the first signal received from the at least two sensors.
